(19) United States
(12) Patent Application Publication
(10) Pub. No.: US 2015/0150659 A1
(43) Pub. Date: Jun. 4, 2015

(54) SYSTEM TO FIX PLASTER MODELS OF TEETH IN ARTICULATORS WITHOUT MAKING USE OF PLASTER

(71) Applicants: Václav Mensa, Tymakov (CZ); Herman Mensa, Osvracin (CZ)

(72) Inventors: Václav Mensa, Tymakov (CZ); Herman Mensa, Osvracin (CZ)

(21) Appl. No.: 14/406,105

(22) PCT Filed: Jun. 4, 2013
(86) PCT No.: PCT/CZ2013/000072

§ 371 Date: Dec. 5, 2014

(30) Foreign Application Priority Data
Jun. 7, 2012 (CZ) PUV 2012-26189
Dec. 12, 2012 (CZ) PUV 2012-27166
May 14, 2013 (CZ) PUV 2013-27922

(51) Int. Cl. A61C 11/08

(52) U.S. Cl. CPC A61C 11/087

(57) ABSTRACT

The system has a form of a movable and fixable structure node, equipped with hinges and/or pins. It consists of a head bush adapted to be fixed in an articulator, said head bush consisting of the dish (1), the lid (2), of the hub (3) with an internal through-orifice, of the ball pin (4), of the cylinder (5), of the plate (6), and of the control element (7). In case the fixation is required, the control element (7) contacts the plate (6) which pushes on the cylinder (5). Said cylinder (5) acts on the ball pin (4) and the force from the ball pin (4) is transferred further on the hub (3) to ensure its fixation against the dish (1). In a variant it can be completed with a counterpart having shape of the structure element (9) which contains the disk plate (109) on the opposite side of which two pairs of movable plates (104) are fixed and equipped with an internal longitudinally-shaped opening. The arrested screw (105) passes through the internal openings of the movable plates (104). In another variant it can be completed with a calibrating pillar which contains two disks (201, 201a) joined with the movable bottom element (203) and with the movable top element (203a) which are joined with a set of ball hinges (202, 202a, 206).

### TECHNICAL FIELD

The proposed invention falls under the field of the dentistry, actually under the dentures, namely among the means to secure dental models or castings respectively for an articulator.

### BACKGROUND ART

The articulators are utilised as a facility for dental-lab technicians in making dental substitutions. The articulators are mechanical devices which enable to simulate the jaw hinge movements. For the needs to make dental substitutions a plaster model of patient's teeth print must be fixed precisely in the actuator.

A primitive and cheap method is to fix the teeth model in the actuator by means of plaster. In such case the dental-lab technician underlies the models in correct position mutually and towards the articulator and sticks those on to the articulator by means of plaster. However, to state the correct position in the free space inside the articulator and to underlay the models is very lengthy procedure. Before beginning of the actual dental-lab technician's expert work, consisting in making dental substitutions, the mere preparation thereof occupies approximately 20 to 30 minutes for one pair of teeth model if sufficient experience is available.

Various adjustable systems to fix teeth models in an articulator represent another possibility. The system described in the document DE 102004052493 is one of them. The device, described here, consists of two plates which are joined mutually with several mandrels. The mandrels are furnished with ball pins which are fastened in the plates due to which the plates can move mutually. Disadvantageously, this solution is complicated due to a great many ball pins involved. Besides, the plates can move in horizontal direction only and cannot be tilted mutually.

In the document CN 201453395 an adjustable articulator is described. In its top part, it contains a ball pin which is fastened to a movable arm. Owing to it, the top part can be moved in all directions and be tilted as well. The disadvantage of this solution is that it must be equipped with several pins to ensure the arm movement. Therefore, it is about the whole special articulator the fabrication of which is difficult and expensive. Also, the servicing thereof is complicated relatively because in order to adjust the required position thereof one must operate individually with several pins and fix them individually.

In the document WO2004014252 a device to fasten a jaw model movably is described. This device is provided with a universal articulated mechanism. With this the jaw model can be tilted arbitrarily with respect to the horizontal line. The disadvantage of this solution is that the fastened jaw model cannot be moved in horizontal direction due to which the model of one jaw cannot be set towards the model of the second jaw.

The described state of the engineering can be compiled so that the hitherto known devices are complicated both for the production and the service and do not allow the fixed models to move in all axes or rotate possibly owing to which it is difficult or even impossible to fix up the models precisely.

With using settable systems to fix plaster models of teeth, it is problematic for the lab technician to work at teeth castings of more patients at the same time. After having dismounted the first patient's castings he must, in order to set the second patient's castings correctly, change the settable systems setting so that the shape-dissimilar castings may be in required position mutually and against the articulator as well. After having returned to work with the first patient's castings he must set the systems in equal position the systems have had during treating the first patient's castings. However, with regard to required accuracy, this is very difficult or even impossible in a last resort. With respect to the extent of movement of certain systems, the lab technician does not know how to set up the systems mutually and therefore there is a problem to repeat the system settings. Owing to it, inaccuracies can originate which must be repaired by the lab technician (additional work). Otherwise the inaccurate teeth substitution will not be located correctly in the patient's mouth.

### DISCLOSURE OF THE INVENTION

The substance of the proposed invention is to create a system structurally to fix plaster teeth models in an articulator. The system consists of a head bush and possibly a structural element. The head bush is adapted to be fixed in a usual articulator. The head bush consists of, a dish, a lid, a hub with internal through-orifice, a ball pin, a cylinder, a plate, and a control element. In an advantageous realization the control element is screw-shaped or cam-shaped.

In the dish bottom there is an orifice through which the smaller-diameter hub part passes. The diameter of the orifice is such that there is an interstice between the orifice edge and the smaller-diameter hub part. The diameter of the larger-diameter hub part is larger than the orifice in the dish. This is in order to prevent the hub from passing or falling through the orifice in the dish respectively. Between the larger-diameter hub part and the dish wall there is an interstice. In the hub the ball pin is located and adapted to join a holder of a plaster model. The ball pin diameter is larger than that of the bottom part of the through-orifice in the hub. This prevents the ball pin from dropping out from the hub. Above the ball pin in the hub the cylinder located which overtops the larger-diameter hub part surface. In the lid, there is a movable plate which can be controlled with a control element. The lid is adapted to be joined to the dish rigidly.

In case the fixation of the actual head bush setting is required, the control element contacts the plate which pushes on the cylinder. The cylinder acts on the ball pin and the force is transferred from the ball pin further on the hub to ensure its fixation towards the dish. Owing to it the ball pin is braced towards the hub and consequently the hub is braced against the dish due to which all movable parts of the head bush are fixed.

In an advantageous realization the dish, lid, hub, and the orifice have circular ground plans. Thanks to it, optimum extent of the movement is reached in all directions in the horizontal plane.

Conformably with the proposed invention the head bush, after having been fixed in the articulator, enables to fasten a holder of the plaster teeth model to the ball pin. Usually, the holder is joined to the model by means of a magnet. Thanks to the combination of the rocking and rotating movement of the ball pin with really unlimited shifting movement of the hub in the horizontal plane, very wide extent of setting is possible. The shifting movement extent is defined with the interstice size between the orifice edge and the hub or between the larger-diameter hub part and the dish wall respectively.

Against the head bush with the teeth models of one jaw, the teeth models of the other jaw are fixed in the articulator. In an advantageous realization the structure element, enabling movement along a vertical axis especially, is used as a counterpart to the head bush. In that case, the teeth models of the second jaw are fastened to this structure element. With this combination, the teeth models can move mutually in all axes and mutual rotation can be applied. Thanks to it the plaster teeth models can be set precisely mutually and placed together in an occlusive plane in the articulator space.

In a particularly advantageous realization this structure element contains a disk plate provided with a dismountable joint and a shape profile to fasten the plaster teeth model. It is advantageous if the dismountable joint is made of a magnet. The plaster teeth model is fastened to a reposition plate which is provided, from the opposite side, with a corresponding counterpart of the shape profile and a magnetic element.

On the opposite sides of the disk plate, two pairs of movable plates are fastened by means of screws, said plates having internal elongated-shape openings. In the direction of longitudinal axes of the screws, the free ends of the movable plates are braced mutually with a brace.

From the outer side the movable plates are overlapped at least partially with pressure plates. Through the internal orifices of the movable plates, orifices in the pressure plates and an orifice in the brace an arrested screw passes. The arrested screw is equipped with a tightening nut on one side and with a head or a lock nut on the second one, with being secured against rotation.

The brace is fastened to the ball pin which can be attached to the articulator. Depending on the stage of tightening of the arrested screw, the brace is fixed firmly to the ball pin or can be rotated around all three axes.

Such realization of the brace in which the brace consists of two semi-plates seems to be optimum. Each semi-plate has a cavity of the shape of the ball pin which is less deep than a half of the ball pin diameter, with the ball pin being situated in the cavities.

In an advantageous realization the arrested-screw cross section is polyhedron-shaped and the openings in the brace and the pressure plates have shape and size corresponding to the arrested-screw diameter to prevent the arrested screw from rotation in the openings.

In view of the fact that every maker of articulators uses his own shape profile on the disk plate or on the reposition plate respectively to fasten the plaster teeth model, it is advantageous if the system is equipped with a transitional plate optionally. Said plate enables to make the joint between various profiles on disk plates and between various reposition plates from various producers. The transitional plate consists of a flat basic body. In the basic body an orifice is made the shape and size of which correspond to the shape profile on the disk plate. On the upper surface of the basic body, delimiting elements are created. The shape and size of the delimiting elements correspond to the shapes and sizes of the shape profiles on the bottom part of the reposition plate. With making the joint, the transitional plate is placed on the desk plate shape profile and the reposition plate is placed on said transitional plate. Mutual position of these parts is fixed with the shape profile and delimiting elements. The stability of this set is maintained with a dismountable joint, advantageously magnetic one. Owing to the simplicity of the transitional plate, the joint between various systems of various makers can be made at minimum costs.

Owing to above mentioned system structures, the disk plate can move with attached plaster teeth model of one jaw in arbitrary direction towards the articulator. The ball pin enables rotation and tilting while the set of movable plates enables to withdraw, approach and set necessary height therefore. The whole system can be controlled with one screw. Therefore, the lab dental technician can set the disk plate in the required position with one hand and fix the whole system simply with the other hand.

In another advantageous embodiment a calibration pillar can be applied with the above mentioned fastening systems of the teeth articulator to set them in a reproducible setting thereof. The calibration pillar contains two disks.

The bottom disk can be fastened to the settable system for fastening the plaster teeth casting and is equipped with a shape cavity and/or a magnetic joint on the bottom side. On the upper side, it is provided with a boss with a ball hinge. The top disk can be attached to the settable system of fastening the plaster teeth casting and is equipped with a shape cavity and/or a magnetic joint on the upper side. On the bottom side it is equipped with a boss with a ball hinge.

Further, the calibration pillar contains a bottom movable element and a top movable element. Each of these movable elements consists of two halves joined with a screw joint. Between movable element halves the ball hinges of the bosses and the ball hinges of a coupling rod are clamped. The movable elements are mutually joined with the ball hinges and the disks. This can be made especially so that, on the surface of the joint halves, each half of the movable element is equipped, on one of its sides, with a cavity having shape of the ball hinge of the boss which is less deep than the half of the diameter of the boss ball hinge. Then the boss ball hinge is located in the cavities. Furthermore, on the surface between the joined halves, each half of the movable element is equipped on its second side with a cavity of the shape of the ball hinge of the coupling rod, with the depth of said cavity being smaller than half of the ball hinge diameter of said coupling rod. Then, in the cavities the coupling rod ball hinge is located. The coupling rod consists of two immovably joined hinges.

In an advantageous realization the boss axis is located outside the disk centre. This is advantageous for space reasons in the space between two disks. Then, the movable elements, attached to the bosses, can be placed one by the other easily.

In further advantageous embodiment, in the place of the boss ball hinge and/or in the place of the coupling rod ball hinge, the movable element is equipped with a tightening screw. Depending on the stage of tightening, the tightening screw contacts the boss ball hinge and/or on the coupling rod ball hinge.

Thanks to described calibrating pillar structure, the calibrating pillar can be easily set according to the settings of the fastening systems in the articulator. The calibrating pillar, having loosened screw joints between the halves of the movable elements, is inserted into the articulator and attached to the settable systems to fasten the plaster teeth castings. In this moment, owing to mutual movable joints with ball hinges between the movable elements and between the movable elements and the disk bosses, the disks adhere completely to settable systems for fastening of the plaster teeth castings and owing to it they copy the positions thereof. With tightening the screw joints in both movable elements, the whole calibrating pillar is fixed. Alternatively, with using the advantageous realization with tightening screws, the screw joints are not tightened completely but they delimit the clearance in ball hinges only. Then the movable element is tightened finally with the tightening screw. Thanks to the structure, it is done so that the screw joint between the halves of the movable element acts here as a pin around which the halves of the movable element are clamped as a lever. One ball hinge is clamped from one side with the half of the movable element and is clamped with the tightening screw from the other side. The second ball hinge is clamped with both halves of the movable element from both sides. Due to this advantageous realization, stronger clamping is ensured.

Afterwards, the calibrating pillar can be taken out of the articulator and can serve in following laboratory works at given concrete pair of teeth castings as reference setting of systems to fasten plaster teeth castings. With working further at this concrete pair of teeth castings, the systems to fasten plaster teeth castings in the articulator are set first according to the calibration pillar which has been preset according to this pair of teeth castings. After having set the system of fastening the plaster teeth castings, the calibrating pillar is taken out of the articulator and the teeth castings can be fitted in the absolutely equal position as it was in former installation in the articulator.

Compared to hitherto known solutions, the proposed invention has the advantage of being able to set the teeth models very swiftly, precisely and advantageously. The compactness and simple services of this invention belong to further advantages and so is the possibility to fix the whole head bush with only one control element. It can be fastened in the usual articulator without necessity to modify it.

With using the calibration pillar, one articulator can be used for laboratory works at several pairs of teeth castings. Equally, the teeth castings can be sent, together with the preset calibrating pillar, between various dental laboratories or maybe between a dental consulting room and a dental laboratory. Owing to it, the costs of buying greater number of articulators can be saved, with one constantly set articulator being available for every actually worked pair of teeth castings to reach the required accuracy without having the proposed calibrating pillar.

### BRIEF DESCRIPTION OF DRAWINGS

The exemplary embodiment of the proposed solution is described with reference to drawings where there is on:

FIG. 1—the side view of the articulator with the head bush and the structure element;

FIG. 2—vertical cross section through the head bush;

FIG. 3—schematic side view of the structural element;

FIG. 4—transversal cross section of the structural element in the place of the ball pin in the embodiment of the brace with semi-plates;

FIG. 5—side view of the articulator fitted with two structural elements and one transitional plate;

FIG. 6—ground-plane view of the transitional plate with the central orifice;

FIG. 7—ground-plane and side views of the transitional plate with the orifice joined with one of the edges;

FIG. 8—schematic picture of the structural realization of the calibrating pillar.

### BEST MODES FOR CARRYING OUT THE INVENTION

### Example No. 1

The system to fasten the plaster teeth models in the articulators without using plaster has the form of a movable and settable structural node. It consists of a head bush which is adapted to be fixed in the articulator. The head bush consists of the dish 1, of the lid 2, of the T-shaped hub 3 with an internal through-orifice, of the bull pin 4, of the cylinder 5 of the plate 6 and of the screw-shaped control element 7. In the bottom of the dish 1 there is an orifice 8 through which the smaller-diameter part of the hub 3 passes. The diameter of the orifice 8 is such that there is an interstice M between the edge of the orifice 8 and the smaller-diameter part of the hub 3. The larger-diameter part of the hub 3 has larger diameter than that of the orifice 8. This is to prevent the hub 3 from passing through the orifice 8. Between the larger-diameter part of the hub 3 and the wall of the dish 1 there is an interstice M′.

In the hub 3 the ball pin 4 is placed which is adapted to join the holder 10 of the plaster model, with the diameter of the ball pin 4 being larger than that of the bottom part of the through-orifice in the hub 3. Above the ball pin 4 the cylinder 5 is located in the hub 3, said cylinder 5 over-tapping the surface of the larger-diameter part of the hub 3. In the lid 2 the movable plate 6 is located which is controllable by means of the screw-shaped control element 7.

The lid 2 is adapted to be joined rigidly to the dish 1. In this example the rigid joint is made by screwing the lid 2 into the dish 1.

In case the fixation is required, the tightened-screw-shaped control element 7 contacts the plate 6 which pushes on the cylinder 5. The cylinder 5 acts on the ball pin 4 and the force from the ball pin 4 is transferred further to the hub 3 in order to ensure its fixation towards the dish 1.

In this example the dish 1, the lid 2, the hub 4, and the orifice 8 have circular ground plans. In the articulator the head bush serves to fix the teeth model of the upper jaw. The structure element 9 serves to fix the teeth model to the bottom jaw, said structure element 9 enabling the movement along the vertical and longitudinal axes of the jaw in this example.

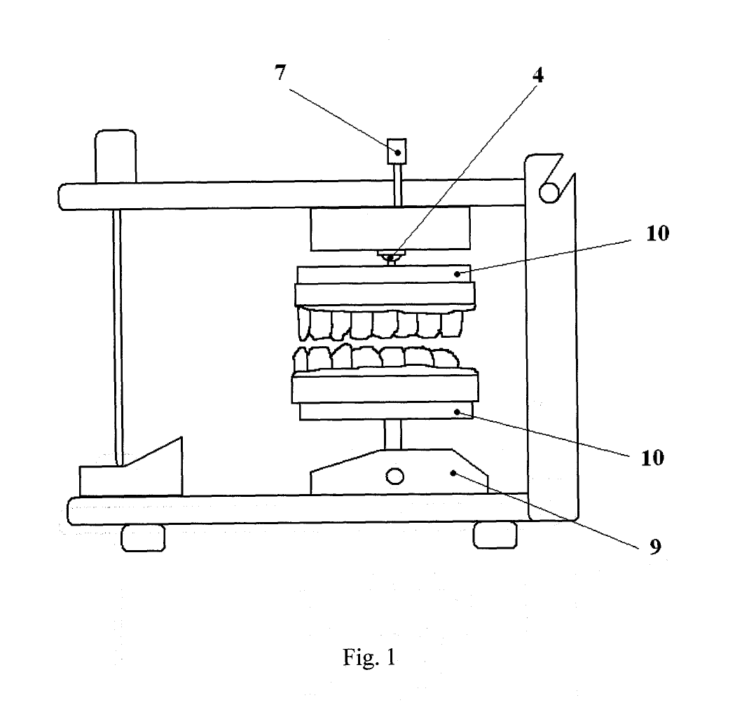

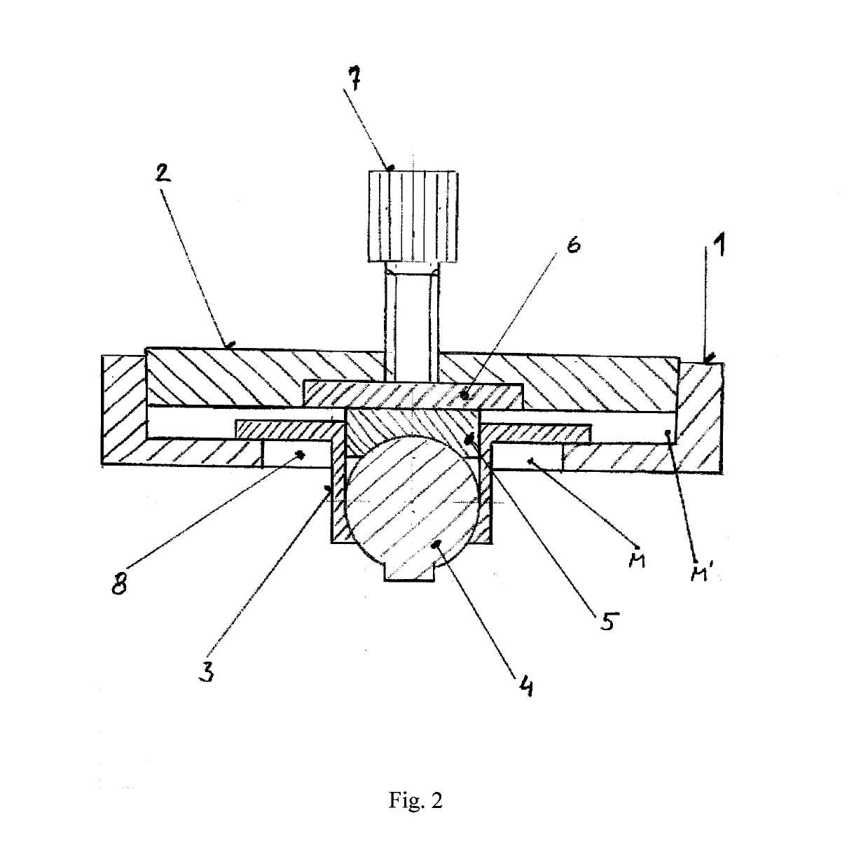

The exemplary realization is perceptible on FIGS. 1 and 2.

### Example No. 2

Compared to the example no. 1, in this example the concrete realization of the structure element 9 is described. The structure element 9 contains the disk plate 109, equipped with a dismountable joint and a shape profile to fix the plaster teeth model of one jaw. In this case the dismountable joint consists of a magnet. On opposite sides of the disk plate 109 two pairs of the movable plates 104 are fastened by means of the screws 108, said movable plates being equipped with internal elongated-shape openings. Free ends of the movable plates 104 are braced mutually by means of the brace 110 in the directions of longitudinal axes of the screws 108.

From the outer side the movable plates 104 are overlapped, at least partially, with the pressure plates 103, with the arrested screw 105, equipped with the tightening nut 106 on one side and the lock nut 107 on the other side, passing through internal openings of the movable plates 104, through openings in the pressure plates 103, and through the opening in the brace 110. The brace 110 is fastened to the ball pin 101 which can be fastened to the articulator. In dependence on the tightening stage of the arrested screw 105, the brace 110 is firmly fixed on the ball pin 101 or can be rotated around all three axes. Here, the brace 110 consists of two semi-plates 102. Each semi-plate 102 has a cavity in the shape of the ball pin 101 and is less deep than the half diameter of the ball pin 101. The ball pin 101 is located in the cavities.

The cross section of the arrested screw 105 is polyhedron-shaped, namely hexahedron-shaped in this case. In the brace 110 and in the pressure plates 103, the shape and size of the openings correspond to the cross section of the arrested screw 105 in order to prevent said arrested screw 105 from rotating in the orifices.

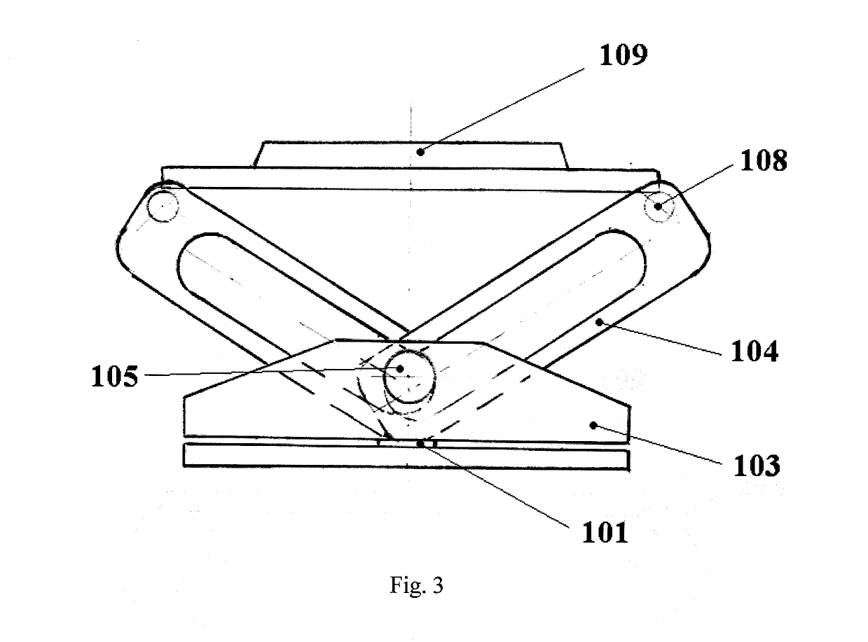

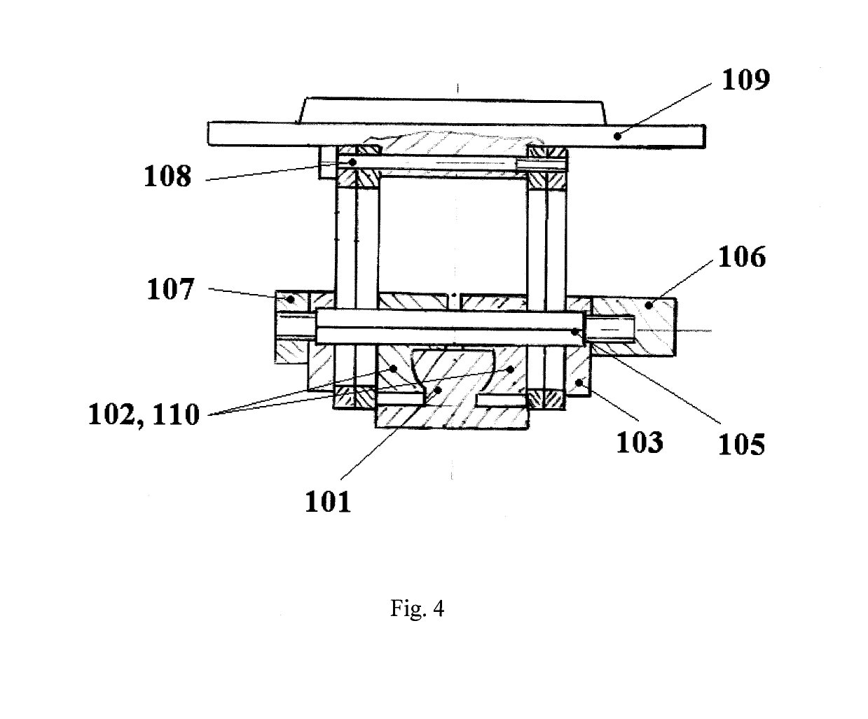

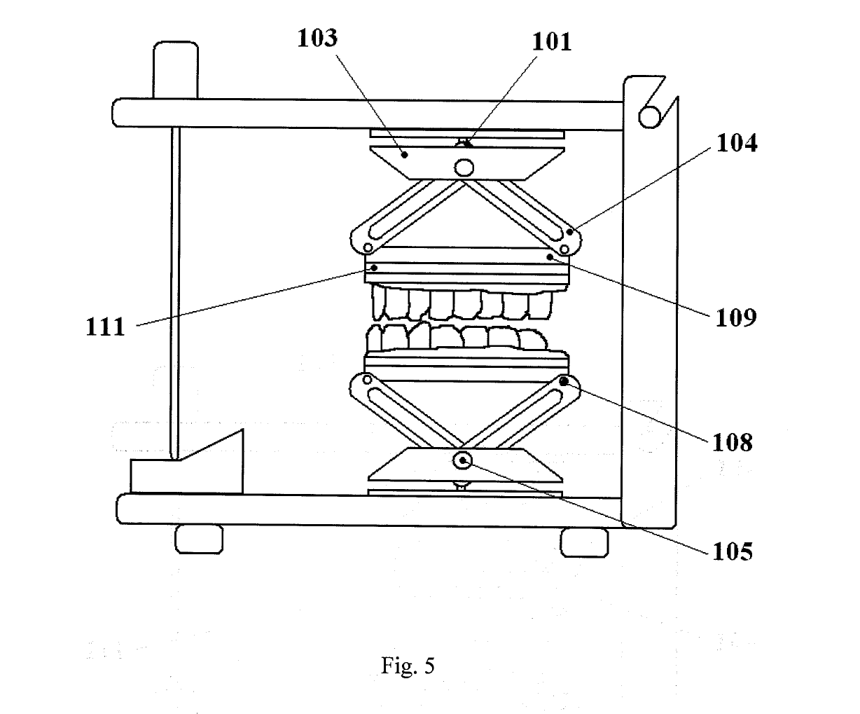

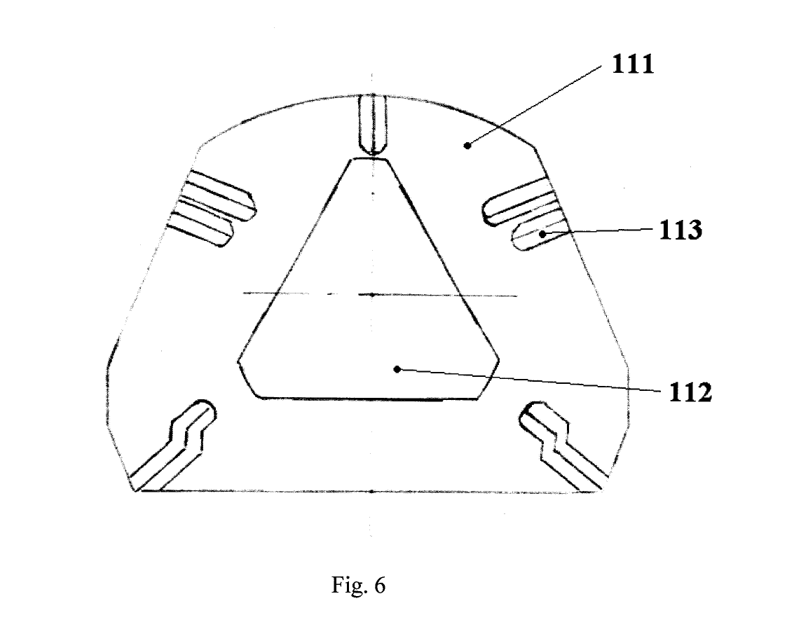

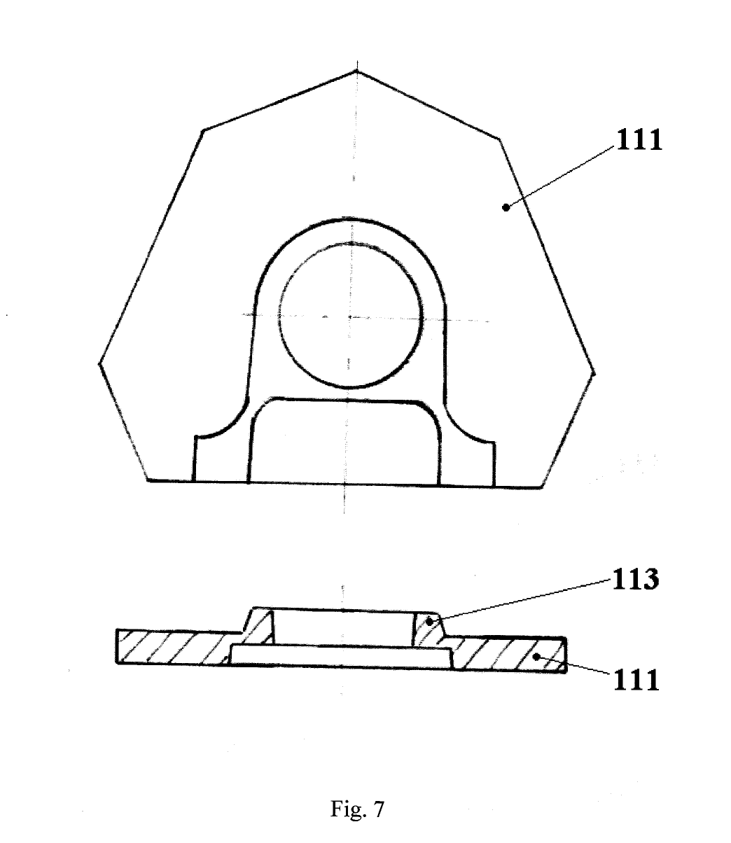

In this case the structure element is completed with the transitional plate. The transitional plate consists of the flat basic body 111. In the basic body 111 the orifice 112 is made of which the shape and size correspond to the shape profile on the disk plate 109, being triangleshaped with bevelled corners in this case. On the upper surface of the basic body 111 the delimiting groove-shaped elements 113 are made. An exemplary embodiment is perceptible on FIGS. 3 to 6. Another shape of the transitional plate is presented on the FIG. 7. The shape of the basic body 111 is an irregular heptahedron. In this case the orifice 112 is interconnected with one of the edges and the delimiting elements 113 resemble the shape of the fitting around the orifice 112.

### Example No. 3

In his example the calibrating pillar is used together with the invention described in the example no. 1 and the example no. 2. The exemplary realization of the calibrating pillar of fastening systems of the dental articulator contains two disks 201, 201a. The bottom disk 201 can be attached to the settable system to fasten the plaster teeth castings and is equipped with a shape cavity and a magnetic joint in the bottom side. On the top side, it is provided with the boss 202 with the ball hinge.

The top disk 201a can be fastened to the settable system to fasten the plaster teeth castings and is equipped with a shape cavity and a magnetic joint on the top side. On the bottom side it is equipped with the boss 202a and a ball hinge.

Besides, the calibrating pillar contains the movable bottom element 203 and the movable top element 203a. Each of the movable elements 203, 203a consists of two halves joined with a screw joint. Further, in this case each movable element 203, 203a is provided with the tightening screw 207 from outside and in the place of the ball hinge of the bosses 202, 202a. Depending on the stage of tightening, the tightening screw 207 bears against the ball hinge of the bosses 202, 202a. Between the halves of the movable elements 203, 203a the ball hinges of the bosses 202, 202a and the ball hinges of the coupling rod 206 are clamped. The movable elements 203, 203a are joined mutually and with the disks 201, 201a by means of the ball hinges.

This is made so that on the surface between the joined halves each half of the movable element 203, 203a has, on one of its sides, the cavity 204 in the shape of ball hinge of the boss 202, 202a which is less deep than half the diameter of the ball hinge of the bosses 202, 202a. In the cavities 204 the ball hinge of the bosses 202, 202a is situated.

Further, on the surface between the joined halves, each half of the movable elements 203, 203a is, on its second side, equipped with the cavity 205 in the shape of the ball hinge of the coupling rod 206 which is less deep than half the diameter of the ball hinge of the coupling rod 206. In the cavities 205 the ball hinge of the coupling rod 206 is located. The coupling rod 206 consists of two immovably joined hinges. In this case the axes of the bosses 202, 202a are located outside the centre of the disk 201, 201a.

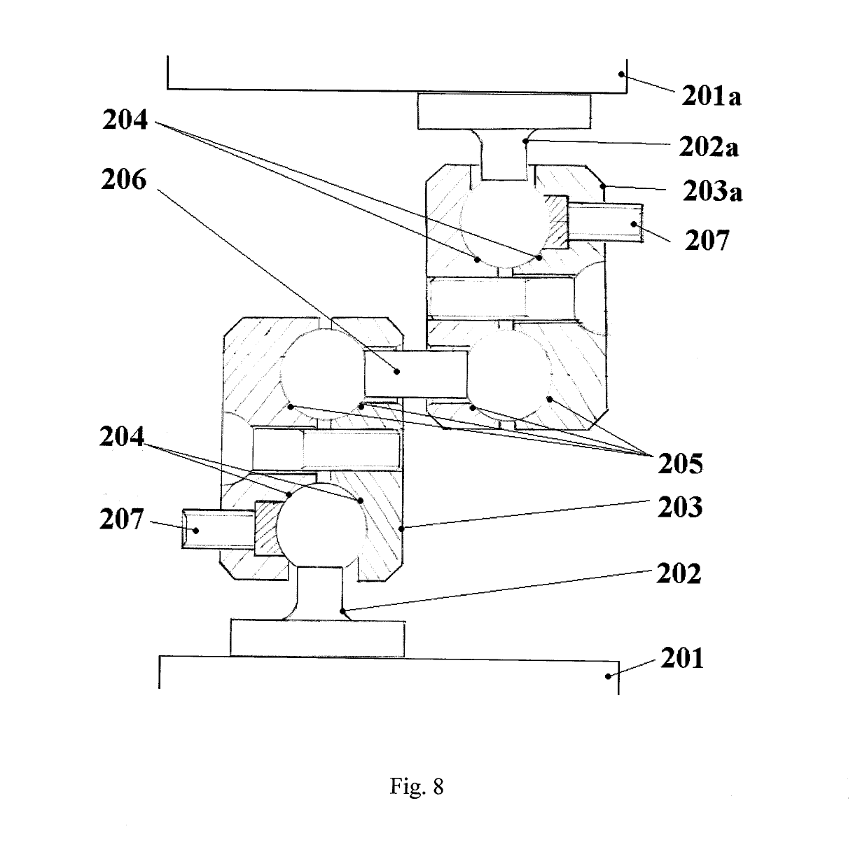

The exemplary embodiment is presented on the FIG. 8.

### LIST OF REFERENCE NUMBERS

1—dish
2—lid
3—hub
4—ball pin
5—cylinder
6—movable plate
7—control element
8—orifice
9—structure element
10—plaster-model holder
M—interstice
M′—interstice
101—ball pin
102—semi-plate
103—pressure plate
104—movable plate
105—arrested screw
106—tightening nut
107—lock nut
108—screw
109—disk plate
110—brace
111—basic body
112—orifice
113—delimiting element
201—bottom disk
201a—top disk
202—bottom-disc boss
202a—top-disc boss
203—movable bottom element
203a—movable top element
204—cavity for the boss ball-hinge
205—cavity for the coupling-rod ball-hinge
206—coupling rod
207—tightening screw

1. A system to fix plaster models of teeth in articulators without making use of plaster, said system having a shape of a movable and fixable structure node equipped with hinges and/or pins, wherein said system comprises:
a head bush adapted to be fixed in an articulator, said head bush being composed of a dish, a lid, a hub with an internal-through orifice, a ball pin, a cylinder, a plate, a control element, and an orifice through which a smaller diameter part of the hub passes through,
wherein the orifice is in the bottom of the dish, the orifice having such diameter that between the edge of the orifice and the smaller diameter part of the hub there is a first interstice,
wherein the hub comprises a larger diameter part that has a larger diameter than the orifice to prevent the hub from passing through the orifice,
wherein there is a second interstice between the larger diameter part of the hub and the wall of the dish (1),
wherein the ball pin is located in the hub and is adapted to be attached to a plaster-model holder, the diameter of the ball pin being larger than the diameter of the bottom part of the through-orifice in the hub,
wherein the cylinder is located in the hub above the ball pin, said cylinder over-topping the surface of the larger diameter part of the hub,
wherein the movable plate is movable and controllable with the control element, wherein the plate is located in the lid, the lid being adapted to be joined firmly to the dish, and
wherein when the fixation is required, the control element is able to contact the plate to thereby push the cylinder, wherein said cylinder is then capable of acting on the ball pin, wherein the force from the ball pin is capable of being transferred to the hub to thereby ensure fixation of the hub towards the dish.

2. The system to fix plaster models of teeth in articulators without making use of plaster according to claim 1, wherein the dish, the lid, the hub, and the orifice have circular ground planes.

3. The system to fix plaster models of teeth in articulators without making use of plaster according to claim 1, wherein the control element is in the form of a screw or a cam.

4. The system to fix plaster models of teeth in articulators without making use of plaster according to claim 1, wherein the head bush serves to fix the teeth model of one jaw and the structure element serves to fix the teeth model of a second jaw, the structure element enabling the movement along the vertical axis above all.

5. The system to fix plaster models of teeth in articulators without making use of plaster according to claim 4, wherein the structure element contains a disk plate, equipped with a dismountable joint and a shape profile to fix the plaster teeth model of one jaw, wherein the disk plate further comprises two pairs of the movable plates fixed on opposite sides of the disk plate by of the screws, wherein the movable plates are equipped with internal longitudinally-shaped openings where the free ends of the movable plates are braced mutually by a brace, wherein the outer side of the movable plates are at least partially overlapped with pressure plates, wherein an arrested screw passes through the internal openings of the movable plates, through the openings in the pressure plates, and through the opening in the brace, wherein the arrested screw is equipped with a tightening nut on one side and with a head or a lock nut, and wherein the brace is fixed to the ball pin and is capable of being fixable to the articulator and, depending on the tightening stage of the arrested screw, the brace is capable of being rotatable around all three axes.

6. The system to fix plaster models of teeth in articulators without making use of plaster according to claim 5, wherein the brace comprises two semi-plates, each semi-plate being equipped with a cavity in the shape of the ball pin, wherein the cavities are less deep than half the diameter of the ball pin, and the ball pin is located in the cavities.

7. The system to fix plaster models of teeth in articulators without making use of plaster according to claim 5, wherein the arrested screw is polyhedron-shaped in the cross section and the openings in the brace and the pressure plates have shapes and sizes corresponding to the cross section of the arrested screw to prevent the arrested screw from rotating in the openings.

8. The system to fix plaster models of teeth in articulators without making use of plaster according to claim 5, wherein the dismountable joint on the disk plate comprises a magnet.

9. The system to fix plaster models of teeth in articulators without making use of plaster according to claim 5, wherein the system is equipped with a transitional plate comprising a flat basic body containing an orifice, wherein the flat basic body orifice has a shape and size corresponding to the shape profile of the disk plate, and wherein the upper surface of the flat basic body comprises delimiting elements.

10. The system to fix plaster models of teeth in articulators without making use of plaster according to claim 1, wherein the system contains a calibrating pillar of fastening systems containing a bottom disk and a top disk, the bottom disk being fixable to a settable system for fastening the plaster teeth castings, wherein the bottom disk is equipped with a shape cavity and/or a magnetic joint on its bottom side and a first boss with a ball hinge on its upper side, wherein the top disk is fixable to the settable system for fastening the plaster teeth castings, wherein the top disk is equipped with a shape cavity and/or a magnetic joint on its upper side and equipped with a second boss with a ball hinge on its bottom side, wherein the system comprises a movable bottom element and a movable top element, each of the movable elements comprising two halves joined with a screw joint, and wherein the ball hinges of the first and second bosses and the ball hinges of a second brace are clamped between the halves of the movable elements, wherein the movable elements are joined mutually and to the top and bottom disks by means of the ball hinges from a coupling rod, wherein the coupling rod comprises two hinges that are joined immovably.

11. The system to fix plaster models of teeth in articulators without making use of plaster according to claim 10, wherein the axis of the first and second bosses is located outside the centre of the respective disks.

12. The system to fix plaster models of teeth in articulators without making use of plaster according to claim 10, wherein the moving elements are is equipped with a second fastening screw from outside, in the place of the ball hinge of the first and second bosses and/or in the place of the ball hinge of the coupling rod, wherein the fastening screw, depending on the stage of fastening, is capable of contacting the ball hinge of the first and second bosses or the ball hinge of the coupling rod.
